(19) United States
(12) Patent Application Publication
(10) Pub. No.: US 2024/0042633 A1
(43) Pub. Date: Feb. 8, 2024

(54) Shaving Apparatus

(71) Applicant: Willis Tribe Pty Ltd, Westleigh, NSW (AU)

(72) Inventors: Susan Elizabeth Parry, Westleigh, NSW (AU); Benjamin Jerry Sterrett, North Turramurra, NSW (AU)

(73) Assignee: Willis Tribe Pty Ltd, Westleigh, NSW (AU)

(21) Appl. No.: 18/266,410

(22) PCT Filed: Dec. 10, 2021
(86) PCT No.: PCT/AU2021/051481

§ 371 Date: Jun. 9, 2023

(30) Foreign Application Priority Data
Dec. 10, 2020 (AU) 2020904608

(51) Int. Cl. B26B 21/40; B26B 21/52

(52) U.S. Cl. CPC B26B 21/4012; B26B 21/521; B26B 21/527; B26B 21/525

(57) ABSTRACT

A shaving apparatus (10) includes a base (12) having a user holding face (14) and an opposing razor holding face (18). The razor holding face (18) defines a cartridge opening (20) operatively adapted to enclose a razor cartridge. The shaving apparatus (10) further includes a user holding formation (14) operatively associated with the base (12) and outwardly extending from the razor holding face (18) of the base (12). The user holding face (16) includes ahead (52) laterally spaced apart from the base (12) wherein the base (12) is operatively adapted to be held by fingers of a user located between the user holding face (16) of the base (12) and the head (52) of the user holding formation (14).

### FIELD

The invention concerns a shaving apparatus. In one non-exclusive aspect the invention concerns a shaving apparatus for use in body shaving, such as shaving the legs of a user.

### BACKGROUND

It is customary in most Western countries for women to engage in leg shaving for aesthetic purposes. Among men, leg shaving is common among athletes who compete in cycling and swimming. Leg shaving can be undertaken with the use of either electrical or manual razors. A typical manual razor includes (i) a razor cartridge comprising one or more razor blades, and (ii) a transverse handle removably secured to the razor cartridge.

In human anatomy the functional position is widely understood to allow optimum function while offering maximum stability, control, strength and precision. The functional position of the wrist and hand is (i) wrist complex in slight tension (20°) and slight ulnar deviation (10°), and (ii) fingers moderately flexed at the metacarpophalangeal joints (45°) and proximal interphalangeal joints (30°). In facial shaving the wrist and hand will operate within those ranges. In the case of body shaving applications, however, the wrist and hand will operate well outside those ranges. A user manipulating the hand and wrist in such relatively awkward positions have significantly reduced control over the shaving razor.

### OBJECT

It is an object of the present invention to provide an alternative shaving apparatus which addresses the drawbacks associated with body shaving using conventional shaving razors or at least to provide a useful alternative.

### SUMMARY

According to a first aspect there is disclosed herein a shaving apparatus including:
a base having a user holding face and an opposing razor holding face, the razor holding face defining a cartridge opening operatively adapted to enclose a razor cartridge; and
a user holding formation operatively associated with the base and outwardly extending from the razor holding face of the base, the user holding face including a head laterally spaced apart from the base, wherein the base is operatively adapted to be held by fingers of a user located between the user holding face of the base and the head of the user holding formation.

Preferably the user holding formation is operatively adapted to enable a user to hold the base in a hand of a user whereby the second, third, fourth and fifth metacarpals of the hand are substantially parallel with the razor cartridge located inside the cartridge opening.

Preferably the user holding formation is operatively adapted to secure the base to a plurality of fingers of the user such that the fingers of the user are substantially parallel with the razor cartridge located inside the cartridge opening.

Preferably the user holder formation co-operates with the base to define a first finger position and a second finger position respectively for receiving a first and a second finger of a hand of a user, the first and second finger positions being separated from one another by a divider of the user holding formation, the divider outwardly extending from the user holding face of the base.

Preferably the razor holding face includes an elongate first base member and a second laterally spaced apart and co-extending elongate second base member.

Preferably the cartridge opening is formed between the first and second base members.

Preferably the razor cartridge includes a cutting face and an opposing rear face, the cartridge opening being configured so that a gap is formed between the razor holding face of the base and the rear face of the razor cartridge secured in the cartridge opening.

Preferably the first and second base members define a cartridge holding formation to secure the razor cartridge within the cartridge opening.

Preferably the cartridge holding formation includes a first set of openings in the first base member and an opposing second set of openings in the second base member.

Preferably each opening of the first set of openings has a first shape while each opening of the second set of openings has a second shape, the configuration of the first shape being different to that of the second shape.

Preferably the user holding face of the base includes a gripping formation to facilitate purchase between the first and second fingers of the user and the base.

Preferably the gripping formation comprises (i) a plurality of protrusions outwardly extending from the user holding face of the base, or (ii) a plurality of recesses.

Preferably the divider includes a first wall and an opposing second wall, wherein the first and second wall curve inwardly to accommodate the first and second fingers of the user respectively.

Preferably the head is transversely orientated relative to the divider.

Preferably the base and the head in use cooperate to attach the shaving apparatus to the first and second fingers of a user.

Preferably the base and the head are adapted to cooperate to provide a three-point contact between each of the first and second fingers of the user and the shaving apparatus.

Preferably the head includes a shaving direction indicator.

According to a third aspect there is disclosed herein a razor cartridge operatively adapted for use with the shaving apparatus of the first and second aspect.

### BRIEF DESCRIPTION OF THE DRAWINGS

Preferred embodiments of the invention will be described hereinafter, by way of examples only, with reference to the accompanying drawings wherein:

FIG. 1 is a perspective view of an embodiment shaving apparatus;

FIG. 2 is a top view of the shaving apparatus;

FIG. 3 is a bottom view of the shaving apparatus;

FIG. 4 is a front view of the shaving apparatus;

FIG. 5 is a left side view of the shaving apparatus;

FIG. 6 is a rear view of the shaving apparatus;

FIG. 7 is a right side view of the shaving apparatus;

FIG. 8 is a top view of a hand of a user holding the embodiment shaving apparatus of FIG. 1;

FIG. 9 is a plan view of the palm of the user of FIG. 8 holding the embodiment shaving apparatus;

FIG. 10 is a side view of the hand of the user showing a finger holding the embodiment shaving apparatus; and

FIG. 11 is an exploded perspective view of an embodiment razor cartridge to be located within the shaving apparatus of FIG. 1.

### DESCRIPTION OF PREFERRED EMBODIMENTS

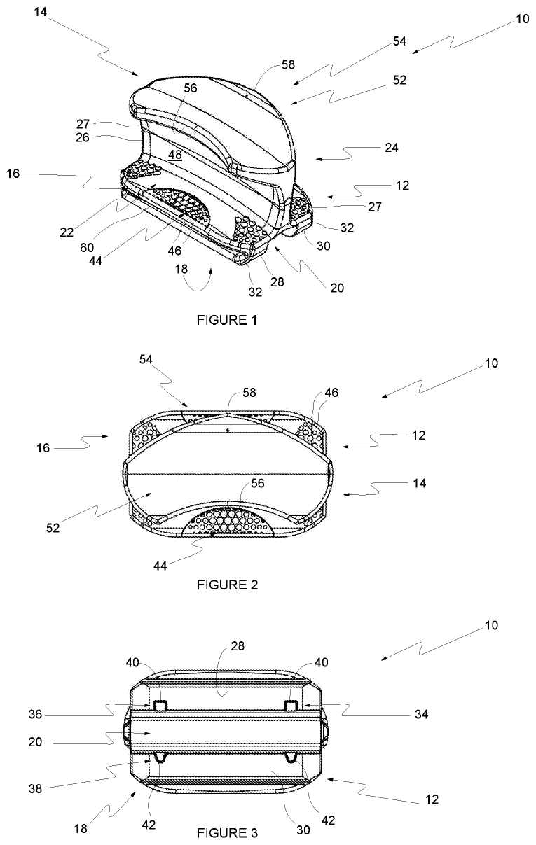

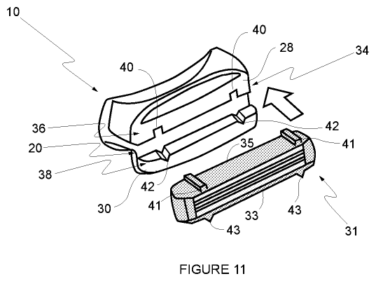

FIGS. 1-7 show an embodiment shaving apparatus, generally indicated with the reference numeral 10. The shaving apparatus 10 includes a base 12 and a user holding formation 14 operatively attached to the base 12. The base 12 includes a user holding face 16 and an opposing razor holding face 18. The razor holding face 18 defines an oblong cartridge opening 20 operatively adapted to receive, hold and enclose a razor cartridge 31, shown in FIG. 11. The razor cartridge 31 is disposable and can be replaced when it has become blunt.

The embodiment user holding formation 14 is operatively adapted to enable a user to hold the base 12. The embodiment user holding formation 14 is operatively associated with the base 12 and operatively adapted to enable a user to hold the base 12 in a hand in a manner whereby the second, third, fourth and fifth metacarpals of the hand are substantially parallel with the razor cartridge 31 located inside the cartridge opening 20. In the embodiment shaving apparatus 10 the user holding formation 14 is operatively adapted to secure the base 12 to a plurality of fingers of the user such that the fingers of the user are in a position which is substantially parallel with the razor cartridge 31 located inside the cartridge opening 20. In an alternative, non-illustrated embodiment the holding formation 14 is operatively adapted to secure the base 12 to a palm surface of a hand of the user.

The embodiment user holding formation 14 co-operates with the base 12 to define a first finger position 22 and a second finger position 24 respectively for receiving a first and a second finger of a hand of a user. The fingers may be those of either the right hand or the left hand of a user. The first and second finger positions 22, 24 are separated from one another by a divider 26 of the user holding formation 14. The divider 26 outwardly extends from the user holding face 16 of the base 12 and flares outwardly as shown. The divider 26 includes opposing divider edges 27. The divider edges 27 are operatively curved/shaped to allow for a comfortable fit in the web space between the first and second fingers of a user. The divider edges 27 are operatively adapted to position the razor cartridge on the user's hand to provide optimal use and further provides that the shaving apparatus 10 is ambidextrous.

The razor holding face 18 includes an elongate first base member 28 and a second laterally spaced apart and co-extending elongate second base member 30. The cartridge opening 20 is formed between the first and second base members 28, 30. The razor cartridge 31 includes a cutting face 33 and an opposing rear face 35. The embodiment cartridge opening 20 is configured so that a non-illustrated gap is formed between the razor holding face 18 of the base 12 and the rear face 35 of the razor cartridge 31 when secured inside the cartridge opening 20. The gap serves as a water channel to allow for the cleaning of cut debris from the shaving apparatus 10. It is further envisaged that the dimensions of the gap may be increased to provide for additional flexing of a razor blade held by the razor cartridge inside the cartridge opening 20.

It will be noted that outer edges 32 of the first and second base members 28, 30 are filleted. The reason for this is to allow for smooth passage of the shaving apparatus 10 across a user's skin.

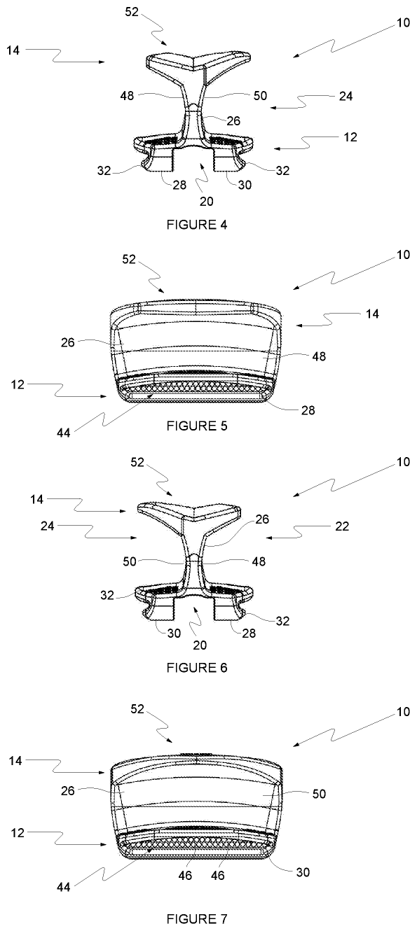

Referring to FIGS. 3 and 4, the first and second base members 28, 30 define a cartridge holding formation 34 adapted to secure a razor cartridge 31 within the cartridge opening 20 and also to provide correct orientation of the razor cartridge within the cartridge opening 20. The embodiment cartridge holding formation 34 includes a first set of openings 36 on the first base member 28 and an opposing second set of openings 38 on the second base member 30. Each opening 40 of the first set of openings 36 has a first shape, here square, while each opening 42 of the second set of openings 38 has a second shape, here is the form of a triangle/arrow. The asymmetrical first and second openings 40, 42 serve both as a visual indicator of the direction of insertion and eliminates the possibility of a razor cartridge being inserted backwards into the cartridge opening 20. The triangle/arrow shape of the second openings 38 also provides a tactile indicator of direction for visually impaired users.

The first set of openings 40 are complementally shaped to a corresponding pair of oblong tabs 41 to be received within the first set of openings 40, while the second set of openings 38 are complementally shaped to a corresponding pair of triangle-shaped tabs 43 on the razor blade cartridge 41. The first and second openings 36, 38 are operably adapted to slidably receive and hold the corresponding tabs 41, 43 of the razor blade cartridge 41 to secure the razor blade cartridge 41 within the cartridge opening 20. It would be appreciated that the cartridge holding formation 34 could take a number of forms, for example the first and second set of opening 36, 38 could be replaced with tabs which are adapted to be slidably received within complemental openings of a corresponding razor cartridge.

The user holding face 16 of the base 12 includes a gripping formation 44 to facilitate purchase between the first and second fingers of the user and the base 12. In the embodiment shaving apparatus 10 the gripping formation 44 comprises a plurality of cylindrical protrusions 46 outwardly extending from the user holding face 16 of the base 12. It is pointed out that the protrusions 46 are located in areas where the first and second fingers of a user will typically meet the user holding face 16. It would be appreciated that the protrusions 46 could be replaced with a plurality of recesses.

The divider 26 includes a first wall 48 and an opposing second wall 50. The first and second walls 48, 50 curve inwardly as shown to accommodate the first and second fingers of the user respectively.

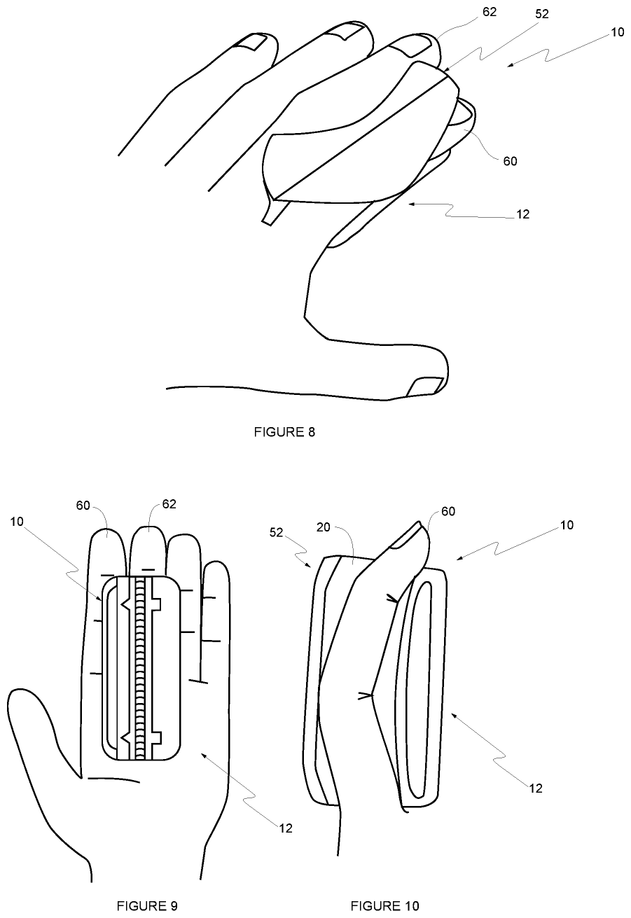

The user holding formation 14 includes a transverse head 52. The head 52 is laterally spaced apart from the base 12 and substantially parallel thereto while operatively secured to the divider 26. Referring to FIGS. 8 to 10, the base 12 and the head 52 in use cooperate to attach the shaving apparatus 10 to the first and second fingers 60, 62 of a user so that the forearm, fingers and the palm are substantially parallel to a cutting plane of the razor cartridge. Specifically, the shaving apparatus 10 is secured to the hand of user by two aspects:
(a) Having the base 12 and head 54 substantially parallel allows for three point contact between the shaving apparatus 10 and a hand of the user, namely (i) the base of the anterior proximal phalanx of the first and second fingers; (ii) the posterior surface of the first proximal interphalangeal (PIP) joint of the first and second fingers (abutting an operative lower surface of the head 54); and (iii) the anterior distal phalanx pad of the first and second fingers; and
(b) The upwardly extending divider 26 when located between the first and second fingers provide for a lateral prehension grip between the first and second fingers.

It is pointed out that there is minimal to no pressure required in the prehension grip. The prehensile force is in effect to provide stability in the grip and grip is in effect provided by the three-point contact discussed above.

It is envisaged that the elongate length of the base 12 of the shaving apparatus 10 will be dimensioned to provide that the very tips of the first and second fingers can wrap around an edge of the base 12 for added stabilisation during a shaving process.

The head 52 includes a shaving direction indicator 54. In this embodiment the shaving direction indicator is provide by the head 52 having a concave portion 56 and an opposing convex portion 58 which co-operate to define an arrow shape indicting the direction in which the shaving apparatus 12 is to be moved to effect shaving.

The shaving apparatus 10 will typically be produced by injection moulding of a plastic.

It will be noted that the base 12 includes open slots 60 shown in FIG. 1. It is envisaged that the slots 60 could be appropriately dimensioned to hold spare razor cartridges.

It is pointed out that the shaving apparatus 10 allows the ring finger and pinkie to remain free. In use those fingers will follow the path of the blade to feel and identify missed hair and that a particular body section requires further shaving.

The invention extends to a razor cartridge adapted for use with the shaving apparatus 10.

In a non-illustrated embodiment the shaving apparatus includes a lubricating strip or lubricating component. In one non-illustrated embodiment the base is produced from lubricating material.

In a non-illustrated embodiment the shaving apparatus includes a cover for covering the razor blade.

In a non-illustrated embodiment the base and razor cartridge is of unitary construction.

It will be appreciated that the above described shaving apparatus can be embodied in various sizes to appeal to different market segments.

Although the invention has been described with reference to a specific example, it will be appreciated by those skilled in the art that the invention may be embodied in many other forms.

### KEY TO REFERENCE NUMERALS IN DRAWINGS

10 shaving apparatus
12 base
14 user holding formation
16 user holding face
18 razor holding face
20 cartridge oping
22 first finger position
24 second finger position
26 divider
27 divider edge
28 first base member
30 second base member
31 razor cartridge
32 outer edges
33 cutting face
34 cartridge holding formation
35 rear face
36 first opening
38 second opening
40 opening (first set)
41 oblong tabs
42 opening (second set)
43 triangle-shaped tabs
44 gripping formation
46 protrusions
48 first wall
50 second wall
52 head
54 shaving direction indicator
56 concave portion
58 convex portion
60 first finger
62 second finger

1: A shaving apparatus including:
a base having a user holding face and an opposing razor holding face, the razor holding face defining a cartridge opening operatively adapted to enclose a razor cartridge; and
a user holding formation operatively associated with the base and outwardly extending from the user holding face of the base, the user holding formation including a head laterally spaced apart from the base, wherein the base is operatively adapted to be held by fingers of a user located between the user holding face of the base and the head of the user holding formation.

2: A shaving apparatus according to claim 1, wherein the user holding formation is operatively adapted to enable a user to hold the base in a hand whereby the second, third, fourth and fifth metacarpals of the hand are substantially parallel with the razor cartridge located inside the cartridge opening.

3: A shaving apparatus according to claim 1, wherein the user holding formation is operatively adapted to secure the base to a plurality of fingers of the user such that the fingers of the user are substantially parallel with the razor cartridge located inside the cartridge opening.

4: A shaving apparatus according to claim 3, wherein the user holding formation is operatively attached to the base, the user holder formation co-operating with the base to define a first finger position and a second finger position respectively for receiving a first and a second finger of a hand of a user, the first and second finger positions being separated from one another by a divider of the user holding formation, the divider outwardly extending from the user holding face of the base.

5: A shaving apparatus according to claim 4, wherein the razor holding face includes an elongate first base member and a second laterally spaced apart and co-extending elongate second base member.

6: A shaving apparatus according to claim 5, wherein the cartridge opening is formed between the first and second base members.

7: A shaving apparatus according to claim 6, wherein the razor cartridge includes a cutting face and an opposing rear face, the cartridge opening being configured so that a gap is formed between the razor holding face of the base and the rear face of the razor cartridge secured in the cartridge opening.

8: A shaving apparatus according to claim 7, wherein the first and second base members define a cartridge holding formation to secure the razor cartridge within the cartridge opening.

9: A shaving apparatus according to claim 8, wherein the cartridge holding formation includes a first set of openings in the first base member and an opposing second set of openings in the second base member.

10: A shaving apparatus according to claim 9, wherein each opening of the first set of openings has a first shape while each opening of the second set of openings has a second shape, the configuration of the first shape being different to that of the second shape.

11: A shaving apparatus according to claim 10, wherein the user holding face of the base includes a gripping formation to facilitate purchase between the first and second fingers of the user and the base.

12: A shaving apparatus according to claim 11, wherein the gripping formation comprises (i) a plurality of protrusions outwardly extending from the user holding face of the base, or (ii) a plurality of recesses.:

13: A shaving apparatus according to claim 12, wherein the divider includes a first wall and an opposing second wall, wherein the first and second wall curve inwardly to accommodate the first and second fingers of the user respectively.

14: A shaving apparatus according to claim 13, wherein the head is transversely orientated relative to the divider.

15: A shaving apparatus according to claim 14, wherein the base and the head in use cooperate to attach the shaving apparatus to the first and second fingers of a user.

16: A shaving apparatus according to claim 15, wherein the base and the head are adapted to cooperate to provide a three-point contact between each of the first and second fingers of the user and the shaving apparatus.

17: A shaving apparatus according to claim 16, wherein the head includes a shaving direction indicator.

18. (canceled)

19: A razor cartridge operatively adapted for use with a shaving apparatus according to claim 1.

20: A razor cartridge operatively adapted for use with a shaving apparatus according to claim 2.
